(19) United States
(12) Patent Application Publication
(10) Pub. No.: US 2025/0265354 A1
(43) Pub. Date: Aug. 21, 2025

(54) INFORMATION PROCESSING SYSTEM, INFORMATION PROCESSING METHOD, AND COMPUTER PROGRAM PRODUCT

(71) Applicant: KABUSHIKI KAISHA TOSHIBA, Tokyo (JP)

(72) Inventors: Hiroho WADA, Yokohama Kanagawa (JP); Tatsuya UEHARA, Kawasaki Kanagawa (JP); Jun KANAI, Inagi Tokyo (JP); Yurie SHINKE, Kawasaki Kanagawa (JP); Ryuiti KOIKE, Kawasaki Kanagawa (JP); Hayeong SHIN, Ota Tokyo (JP); Yuto MASHIMA, Yokohama Kanagawa (JP)

(73) Assignee: KABUSHIKI KAISHA TOSHIBA, Tokyo (JP)

(21) Appl. No.: 19/051,309

(22) Filed: Feb. 12, 2025

(30) Foreign Application Priority Data
Feb. 19, 2024 (JP) 2024-022603

(51) Int. Cl. G06F 21/57

(52) U.S. Cl. CPC G06F 21/577; G06F 2221/033

(57) ABSTRACT

According to an embodiment, an information processing system includes one or more hardware processors. The one or more hardware processors are configured to: identify a threat type capable of being countered by installed software being security countermeasure software installed in a target system, from among security countermeasure software with a reported vulnerability; calculate a first risk value when a countermeasure is taken by the installed software for a threat of the identified threat type; calculate a second risk value when no countermeasure is taken by the installed software for the threat of the identified threat type; and output damage potential information including risk value change information representing a change in the second risk value with respect to the first risk value.

### CROSS-REFERENCE TO RELATED APPLICATIONS

This application is based upon and claims the benefit of priority from Japanese Patent Application No. 2024-022603, filed on Feb. 19, 2024; the entire contents of which are incorporated herein by reference.

### FIELD

Embodiments described herein relate generally to an information processing system, an information processing method, and a computer program product.

### BACKGROUND

Numerous new software vulnerabilities have been reported, and systems are known to diagnose vulnerability risks to software on the basis of vulnerability information published by vendors and the like.

Vulnerabilities in security countermeasure software affect not only the software itself, but also a target system countered by the security countermeasure software. However, in the related art, even when vulnerabilities are found in security countermeasure software, evaluating the risk of the target system countered by the software has been difficult. That is, in the related art, evaluating the risk to the target system due to vulnerabilities in the security countermeasure software has been difficult.

### BRIEF DESCRIPTION OF THE DRAWINGS

FIG. 1 is a schematic diagram of an information processing system of an embodiment;

FIG. 2 is a block diagram of the functional configuration of an information processing device;

FIG. 3 is a schematic diagram of a data structure of correspondence information;

FIG. 4 is a schematic diagram of a data structure of risk analysis result information;

FIG. 5 is a schematic of a display screen;

FIG. 6 is an explanatory diagram of countermeasure levels;

FIG. 7 is a flowchart of an information processing flow;

FIG. 8 is a block diagram of a functional configuration of the information processing device;

FIG. 9 is a schematic diagram of a data structure of impact information;

FIG. 10 is a flowchart of an information processing flow; and

FIG. 11 is a hardware configuration diagram.

### DETAILED DESCRIPTION

According to an embodiment, an information processing system includes one or more hardware processors. The one or more hardware processors are configured to: identify a threat type capable of being countered by installed software being security countermeasure software installed in a target system, from among security countermeasure software with a reported vulnerability; calculate a first risk value when a countermeasure is taken by the installed software for a threat of the identified threat type; calculate a second risk value when no countermeasure is taken by the installed software for the threat of the identified threat type; and output damage potential information including risk value change information representing a change in the second risk value with respect to the first risk value.

Exemplary embodiments of an information processing system, an information processing method, and an information processing program will be explained in detail below with reference to the accompanying drawings.

### First Embodiment

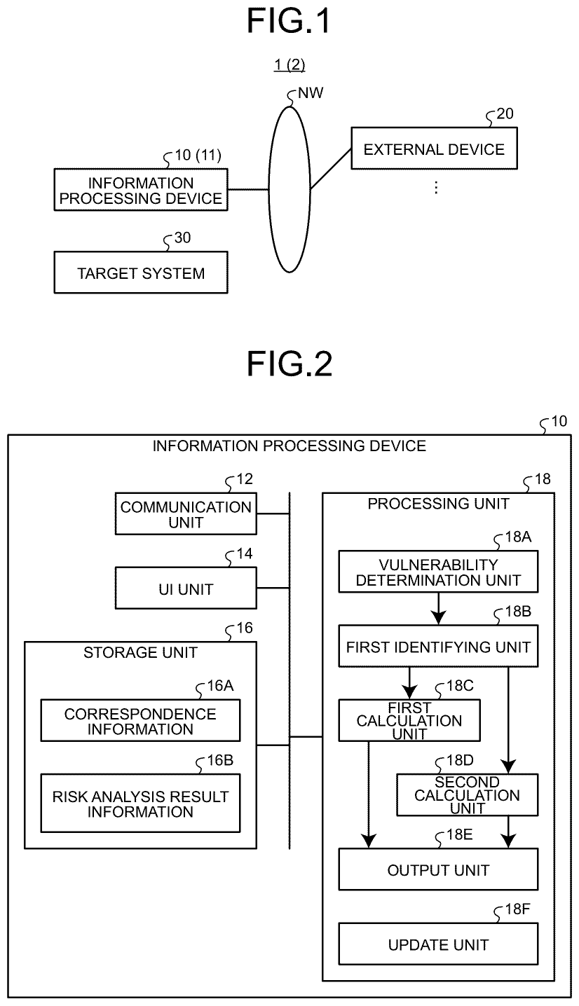

FIG. 1 is a schematic diagram illustrating an example of an information processing system 1 of the present embodiment.

The information processing system 1 includes an information processing device 10 and one or more external devices 20. The information processing device 10 and the external device 20 are communicatively connected via a network NW or the like.

The information processing system 1 is a system for evaluating risks due to vulnerabilities in a target system 30.

The target system 30 is a system for which the risk due to the vulnerability is evaluated. The target system 30 includes one or more computers. One or more pieces of security countermeasure software have been introduced in the target system 30. The target system 30 may also have one or more pieces of security countermeasure software scheduled to be introduced. The introduction implies installation. The present embodiment explains an example in which one or more pieces of security countermeasure software have been installed in the target system 30.

The external device 20 is a dedicated or general-purpose computer. The external device 20 is a device that provides vulnerability information to the information processing device 10 or the like, and receives damage potential information of the target system 30 from the information processing device 10. The damage potential information will be explained below.

The vulnerability information is information representing vulnerabilities published by vendors being manufacturers or suppliers of software and hardware. The vulnerability information includes publicly available information on vulnerabilities published by the vendors. In the present embodiment, the vulnerability information includes at least information on vulnerabilities included in security countermeasure software.

Specifically, for example, the vulnerability information includes one or more of the following item information: evaluation criteria including conformance conditions for the vulnerability and risk values for each of the conformance conditions; the range of possible impacts of the vulnerability on a system device; and countermeasures to address the vulnerability. The conformance condition represents the risk value for the version of software such as security countermeasure software in the form of (conformance condition/risk value), for example, (Software_A10.1 or earlier/4.5 (high)). That is, the conformance condition includes information on the security countermeasure software with a reported vulnerability. The range of possible impacts is expressed, for example, as “arbitrary code execution” or “possibility of information leakage or tampering”. That is, the range of possible impacts includes the threat type of a threat. The range of possible impacts may also include an information security element representing at least one of confidentiality, integrity, and availability affected by the threat of the threat type. The countermeasure is expressed, for example, as “apply patch_001” or “change settings_001 to 100”.

Whenever new vulnerability information is published by a vendor or the like, the external device 20 transmits the vulnerability information to the information processing device 10. For example, the external device 20 acquires new vulnerability information from vulnerability databases such as common vulnerabilities and exposures (CVE), national vulnerability database (NVD), Japan vulnerability notes (JVN) iPedia, or the like, and transmits the acquired vulnerability information to the information processing device 10. The information processing device 10 may directly acquire the vulnerability information from these vulnerability databases.

The information processing device 10 is an information processing device for evaluating a risk to the target system 30 due to vulnerabilities in security countermeasure software on the basis of the vulnerability information. The information processing device 10 is a dedicated or general-purpose computer.

FIG. 2 is a block diagram illustrating an example of the functional configuration of the information processing device 10.

The information processing device 10 includes a communication unit 12, a user interface (UI) unit 14, a storage unit 16, and a processing unit 18. The communication unit 12, the UI unit 14, the storage unit 16, and the processing unit 18 are connected via a bus or the like to be able to exchange data or signals.

At least one of the UI unit 14 and the storage unit 16 may be communicatively connected to the processing unit 18 via the network NW. That is, at least one of the UI unit 14 and the storage unit 16 may be provided in an external information processing device connected to the information processing device 10 via the network NW. In addition, at least one of the functional units to be explained below, which are included in the processing unit 18, may be provided in the external information processing device. The external information processing device is, for example, an external server, the external device 20, or the like.

The communication unit 12 communicates with the external information processing device such as the external device 20 via the network NW. The UI unit 14 has a function of receiving operation input from a user and a function of outputting various types of information. For example, the UI unit 14 includes a display and an input unit. The display displays various types of information. The display is, for example, a known electro-luminescence (EL) display, a liquid crystal display (LCD), a projection device, or the like. The input unit receives various instructions from the user. The input unit is, for example, a keyboard, a mouse, a touch panel, a microphone, or the like. The UI unit 14 may be configured as a touch panel with an input mechanism and an output mechanism. The UI unit 14 may further include a speaker that outputs audio.

The storage unit 16 stores various types of data. The storage unit 16 is, for example, a semiconductor memory element such as a random access memory (RAM) and a flash memory, a hard disk, an optical disk, or the like. The storage unit 16 may be a storage device provided outside the information processing device 10. The storage unit 16 may be a storage medium. Specifically, the storage medium may be one in which computer programs and various information are downloaded and stored or temporarily stored via a local area network (LAN), the Internet, or the like. The storage unit 16 may include a plurality of storage media.

In the present embodiment, the storage unit 16 stores correspondence information 16A and risk analysis result information 16B. The storage unit 16 stores the correspondence information 16A in advance. The correspondence information 16A may be in a form that is updated by the processing unit 18 to be explained below. The risk analysis result information 16B may be stored in the storage unit 16 in advance, or may be generated and updated by the processing unit 18 to be explained below, or the like. Details of the correspondence information 16A and the risk analysis result information 16B will be explained below.

The processing unit 18 includes a vulnerability determination unit 18A, a first identifying unit 18B, a first calculation unit 18C, a second calculation unit 18D, an output unit 18E, and an update unit 18F.

At least one of the vulnerability determination unit 18A, the first identifying unit 18B, the first calculation unit 18C, the second calculation unit 18D, the output unit 18E, and the update unit 18F is implemented by one or more processors, for example. For example, each of the above units may be implemented by causing a processor such as a central processing unit (CPU) to execute a computer program, that is, by software. Each of the above units may also be implemented by a processor such as a dedicated integrated circuit (IC), that is, by hardware. Each of the above units may be implemented using a combination of software and hardware. When a plurality of processors are used, each processor may implement one of the units or two or more of the units.

As explained above, at least one of these functional units included in the processing unit 18 may be provided in an information processing device outside the information processing device 10. The processing unit 18 may be configured without at least one of the vulnerability determination unit 18A and the update unit 18F.

The vulnerability determination unit 18A determines whether a vulnerability represented by newly reported vulnerability information is a vulnerability to installed software being the security countermeasure software installed in the target system 30.

The vulnerability determination unit 18A acquires vulnerability information by receiving new vulnerability information from the information processing device 10. The vulnerability determination unit 18A may acquire vulnerability information from vulnerability databases such as CVE, NVD, and JVN iPedia.

Subsequently, the vulnerability determination unit 18A determines whether the vulnerability indicated in the acquired new vulnerability information is a vulnerability to the security countermeasure software installed in the target system 30. For example, the vulnerability determination unit 18A reads list information of security countermeasure software that has been or is scheduled to be installed in the target system 30 from the storage unit 16 or the like. Subsequently, the vulnerability determination unit 18A determines whether the vulnerability indicated in the vulnerability information is a vulnerability to the security countermeasure software that has been or is scheduled to be installed in the target system 30 by using, for example, a common platform enumeration (CPE) listed in the Known Affected Software Configurations column of NVD.

The vulnerability determination unit 18A outputs, to the first identifying unit 18B, information representing the security countermeasure software installed in the target system 30 and having a reported vulnerability, the vulnerability being determined on the basis of the new vulnerability information. That is, the vulnerability determination unit 18A selects information on the security countermeasure software installed in the target system 30 from many reports of vulnerability information, and outputs the selected information to the first identifying unit 18B.

The first identifying unit 18B identifies a threat type that can be countered by the installed software being the security countermeasure software installed in the target system 30, out of the security countermeasure software with a reported vulnerability.

First, the first identifying unit 18B identifies the installed software, which is the security countermeasure software installed in the target system 30, out of the security countermeasure software with a reported vulnerability.

For example, the first identifying unit 18B receives, from the vulnerability determination unit 18A, the vulnerability information and information on the installed software installed in the target system 30 and having a vulnerability. The information on the installed software is, for example, identification information of installed software being security countermeasure software that has been installed or is scheduled to be installed in the target system 30. In this case, the first identifying unit 18B reads the information on the installed software received from the vulnerability determination unit 18A to identify the installed software determined by the vulnerability determination unit 18A to be vulnerable to the installed software in the target system 30.

The processing unit 18 may be configured without the vulnerability determination unit 18A. In this case, the first identifying unit 18B may identify the installed software in the target system 30 and having a vulnerability by performing the determination process in the same manner as the vulnerability determination unit 18A by means of the new vulnerability information acquired from the external device 20, an external vulnerability database, or the like. That is, in this case, the first identifying unit 18B may identify the installed software in the target system 30 and having a vulnerability from the known affected software configurations column of CVE or NVD, JVN iPedia, or the like.

The first identifying unit 18B may also identify, as installed software, security countermeasure software that is registered in the correspondence information 16A to be explained below, out of the security countermeasure software having a vulnerability indicated in the acquired vulnerability information.

Subsequently, the first identifying unit 18B identifies a threat type that can be countered by the installed software in the target system 30 and having a reported vulnerability. The first identifying unit 18B identifies the threat type by using the correspondence information 16A.

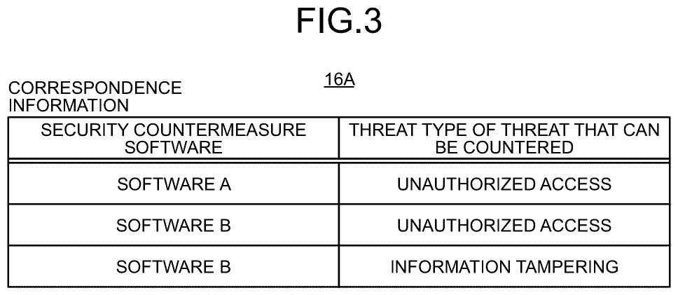

FIG. 3 is a schematic diagram of an example of the data structure of the correspondence information 16A. In the present embodiment, the following explanation is given on the assumption that the correspondence information 16A for each target system 30 is stored in the storage unit 16 in advance.

The correspondence information 16A is a database in which the identification information of the security countermeasure software installed in the target system 30 is associated with the threat types of threats that can be countered by the security countermeasure software identified by the identification information. In the correspondence information 16A, identification information of security countermeasure software scheduled to be installed in the target system 30 may be further registered. That is, in the correspondence information 16A, the threat type of a threat to be defended in the target system 30 and the identification information of the security countermeasure software that has been installed or is scheduled to be installed in order to counter the threat of the threat type are registered in association with each other. The data format of the correspondence information 16A is not limited to a database.

The correspondence information 16A may be stored in the storage unit 16 in advance. The correspondence information 16A may be generated by a user's operating instruction on the UI unit 14, or may be generated in advance by the processing unit 18, the external device 20, or the like, and stored in the storage unit 16 in advance. The threat types of threats that can be countered by the security countermeasure software identified by the identification information registered in the correspondence information 16A may be set arbitrarily by the user, or may be set in the correspondence information 16A in any way by the processing unit 18, the external device 20, or the like. For example, the processing unit 18 and the external device 20 may register threat types in the correspondence information 16A by acquiring information from any edition of the Security Risk Analysis Guide for Control Systems published by the Information-technology Promotion Agency (IPA). Specifically, for example, as the threats (attack methods) in the Security Risk Analysis Guide for Control Systems, Second Edition: unauthorized access, physical intrusion, unauthorized operation, negligent operation, connection of unauthorized media or device, illegal execution of processes, malware infection, information theft, information tampering, information destruction, illegal transmission, functional stop, high-load attacks, theft, and information theft by disassembly at the time of theft or disposal, a threat type of a threat that can be countered by the security countermeasure software installed in the target system 30 may be registered in the correspondence information 16A by being selected from these threat types by the user or the processing unit 18.

One or more threat types may be registered in the correspondence information 16A for one security countermeasure software. For example, as illustrated in FIG. 3, software B being the security countermeasure software may be able to counter threats of both threat types of unauthorized access and information tampering.

As illustrated in FIG. 3, a plurality of types of security countermeasure software may have been installed or be scheduled to be installed in one target system 30.

The first identifying unit 18B reads the threat type associated with the identification information of the installed software, which is the security countermeasure software installed in the target system 30 out of the security countermeasure software with vulnerabilities indicated in the vulnerability information, from the correspondence information 16A. Through this reading process, the first identifying unit 18B identifies the threat types of threats that can be countered by the installed software.

Return to FIG. 2 to continue the explanation.

The first calculation unit 18C calculates a first risk value, which is a risk value for the threats of the threat types identified by the first identifying unit 18B, when countermeasures have been taken by the installed software. The case where countermeasures have been taken by the installed software means a case where countermeasures against the threats of the threat types identified by the first identifying unit 18B are considered to have been taken by the installed software with a reported vulnerability.

For example, the first calculation unit 18C calculates the first risk value on the basis of the risk analysis result information 16B.

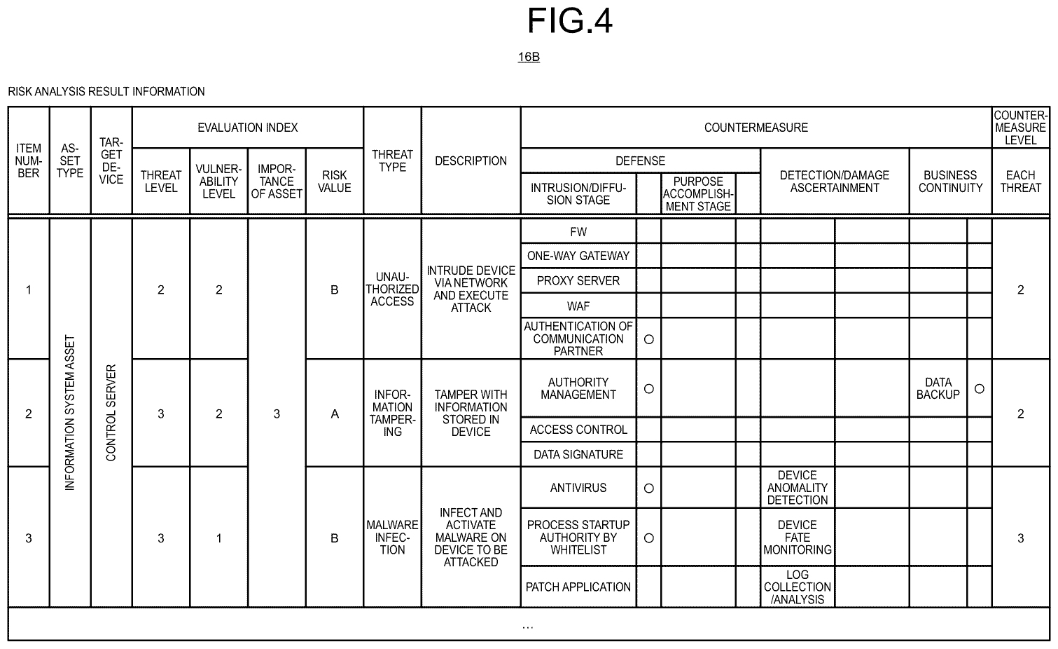

FIG. 4 is a schematic diagram of an example of the data structure of the risk analysis result information 16B.

The risk analysis result information 16B is information representing the result of risk analysis comparing the risk values before and after countermeasures against the threats of the threat types identified by the first identifying unit 18B, when countermeasures have been taken by the installed software.

For the risk analysis, any analysis method having a property that the risk values before and after the countermeasure by the installed software can be compared may be used. Specific examples of the risk analysis include analysis methods in accordance with the “Security Risk Analysis Guide for Control Systems” published by the IPA. The risk analysis result information 16B illustrated in FIG. 4 shows an example of the result of risk analysis according to the above guide published by the IPA.

For example, in the “Security Risk Analysis Guide for Control Systems” published by the IPA, a risk analysis procedure includes the following steps: Step 1: List the assets on the system; Step 2: Examine the importance of the assets and the threat level for each threat; Step 3: Examine the countermeasure implementation status and the countermeasure level (vulnerability level); and Step 4: Mechanically calculate the risk value for each threat based on the importance of the assets, the threat level, and the countermeasure level.

Therefore, for example, in the risk analysis, the device names of devices included in the target system 30 are listed in the columns of target devices, and the threat level and vulnerability level for each importance and threat type of the listed devices are registered in the risk analysis result information 16B. Subsequently, by registering the presence or absence of countermeasures for each device and threat type (mark “O” in FIG. 4 indicates that countermeasures are present), the number of countermeasures taken and the countermeasure level corresponding to the threat level are registered in the risk analysis result information 16B for each device and threat type. The higher the value of the countermeasure level, the more countermeasures are taken. The higher the value of the countermeasure level, the lower the vulnerability level is registered in the risk analysis result information 16B. Subsequently, based on the registered threat level, vulnerability level, and importance of assets, risk values are mechanically determined for each device and threat type and registered in the risk analysis result information 16B.

The risk value determined for each threat type by the risk analysis may be expressed as an alphabet or a numerical value. When the risk value is expressed as an alphabet, the closer the risk value is to A, the higher the risk is, and the closer the risk value is to Z, the lower the risk is. Specifically, for example, the risk value may be expressed on a five-step rating from A to E, with A being the highest risk. On the other hand, when the risk value is expressed as a numerical value, the higher the risk value is, the higher the risk is, and the lower the risk value is, the lower the risk is. Specifically, for example, the risk value may be expressed on a five-step rating from 5 to 1, with 5 being the highest risk. In the present embodiment, the following explanation is given on the assumption that a risk value expressed on a five-step rating from A to E, with A being the highest risk, is registered for each threat type in the risk analysis result information 16B.

When the risk analysis result information 16B is stored in advance in the storage unit 16, the first calculation unit 18C calculates the first risk value by using the risk analysis result information 16B.

For example, it is assumed that the above risk analysis is performed in advance by an external device such as the processing unit 18 or the external device 20 and that the risk analysis result information 16B representing the result of the risk analysis is stored in the storage unit 16 in advance.

In this case, the first calculation unit 18C calculates the first risk value by using the risk analysis result information 16B. For example, the first calculation unit 18C acquires, from the risk analysis result information 16B, the risk values in the risk analysis result information 16B associated with the threat types of threats that can be countered by the installed software, the threat types being identified by the first identifying unit 18B. Through this acquisition process, the first calculation unit 18C calculates the read risk value as the first risk value for the threat of the threat type when the countermeasures have been taken by the installed software. In the present embodiment, the following explanation is continuously given on the assumption that the first calculation unit 18C calculates any of the risk values from A to E, which are expressed by a five-step rating of the alphabet, as the first risk value.

Return to FIG. 2 to continue the explanation.

The second calculation unit 18D calculates a second risk value for the threat type identified by the first identifying unit 18B, which represents the risk value for the threat when no countermeasures have been taken by the installed software. The case where no countermeasures have been taken by the installed software means a case where no countermeasures against the threats of the threat types identified by the first identifying unit 18B are considered to have been taken by the installed software with a reported vulnerability.

The second calculation unit 18D calculates the second risk value by using the same analysis method as the first calculation unit 18C. Therefore, when the first calculation unit 18C calculates the first risk value on the basis of the risk analysis result information 16B, the second calculation unit 18D calculates the second risk value by using the risk analysis method used to generate the risk analysis result information 16B.

For example, it is assumed that the risk analysis result information 16B used by the first calculation unit 18C to calculate the first risk value is based on an analysis method in accordance with the “Security Risk Analysis Guide for Control Systems” published by the IPA. In this case, the second calculation unit 18D calculates the second risk value, which is the risk value for the threat of the threat type identified by the first identifying unit 18B, in accordance with the “Security Risk Analysis Guide for Control Systems” when no countermeasures have been taken by the installed software.

In the process of risk analysis, the second calculation unit 18D uses information regarding whether the security countermeasure software against the threat has been installed. However, even though the security countermeasure software has actually been installed in the target system 30, the risk analysis is performed assuming that the security countermeasure software has not been installed in the target system 30. This allows the second calculation unit 18D to calculate the second risk value being the risk value for the threat of the threat type identified by the first identifying unit 18B, for which no countermeasure has been taken by the installed software.

For example, in the “Security Risk Analysis Guide for Control Systems” published by the IPA, the risk analysis procedure is to mechanically calculate the risk value for each threat by performing the above steps 1 to 4 in order. Therefore, the second calculation unit 18D can calculate the second risk value, which is the risk value when no countermeasures are taken against threats, by performing a risk analysis by assuming that a countermeasure implementation status by the security countermeasure software with a reported vulnerability is not present in Step 3: Examine the countermeasure implementation status and the countermeasure level (vulnerability level).

When the risk analysis was performed in the past by the first calculation unit 18C, the second calculation unit 18D, or the like, the second calculation unit 18D may perform the risk analysis from the first step 1 of the risk analysis procedure including steps 1 to 4, or from a necessary part in the middle of step 2 or later. For example, it is assumed that the risk analysis is performed in accordance with the “Security Risk Analysis Guide for Control Systems” published by the IPA and the risk analysis result information 16B has already been generated by the processing unit 18 or the like. In this case, the second calculation unit 18D may skip the steps 1 and 2 of the risk analysis procedure including the steps 1 to 4 and perform the risk analysis starting from the step 3. This can reduce the processing time required for the second calculation unit 18D to perform the risk analysis and calculate the second risk value.

In the present embodiment, the following explanation is continuously given on the assumption that the second calculation unit 18D calculates, as the second risk value, any of the risk values from A to E, expressed as a five-step rating in the alphabet, like the first calculation unit 18C.

The risk analysis result information 16B may not be stored in advance in the storage unit 16.

In such a case, the first calculation unit 18C may calculate the first risk value by performing the risk analysis explained above. In detail, the first calculation unit 18C may calculate the first risk value by a risk analysis using any analysis method having a property that the risk values before and after the countermeasures by the installed software can be compared. Specifically, for example, the first calculation unit 18C may calculate the first risk value by using the analysis method explained above in accordance with the “Security Risk Analysis Guide for Control Systems” published by the IPA.

The first calculation unit 18C may also generate the risk analysis result information 16B by the above risk analysis and store the generated risk analysis result information 16B in the storage unit 16. Subsequently, for the next and subsequent calculations of the first risk value, the first calculation unit 18C may calculate the first risk value in the same process as explained above by using the risk analysis result information 16B stored in the storage unit 16.

In this case, the second calculation unit 18D may calculate the second risk value by using the same analysis method as the first calculation unit 18C. For example, it is assumed that the first calculation unit 18C calculates the first risk value by risk analysis using the analysis method in accordance with the “Security Risk Analysis Guide for Control Systems” published by the IPA. In this case, the second calculation unit 18D may calculate the second risk value in the same manner as above by a risk analysis using an analysis method in accordance with the “Security Risk Analysis Guide for Control Systems” published by the IPA.

In the processing unit 18, when the risk analysis result information 16B is not stored in the storage unit 16, the first calculation unit 18C and the second calculation unit 18D may calculate the first risk value and the second risk value, respectively, in the same manner as above by using the same risk analysis method when a vulnerability is reported for the first time. Subsequently, when calculating risk values based on the acquisition of vulnerability information for the second and subsequent times, the first calculation unit 18C and the second calculation unit 18D may calculate the first risk value and the second risk value, respectively, by the above method by using the risk analysis result information 16B generated by the initial risk analysis.

The second calculation unit 18D may also update the risk analysis result information 16B stored in the storage unit 16, by using the analysis result of the risk analysis performed when calculating the second risk value.

For example, it is assumed that the second calculation unit 18D calculates the second risk value by risk analysis using an analysis method in accordance with the “Security Risk Analysis Guide for Control Systems” published by the IPA. In this case, the second calculation unit 18D may reflect, in the risk analysis result information 16B, information representing a change in the risk value when no countermeasures have been taken by the installed software. Specifically, for example, it is assumed that the second calculation unit 18D calculates the second risk value on the basis of certain vulnerability information, which considers no countermeasures against threats of any threat type by software A being the installed software in the target system 30. In this case, the second calculation unit 18D may perform a process of setting the countermeasures corresponding to the threat type of the threat in the risk analysis result information 16B to none (that is, remove “O” from the countermeasure column), and register a newly calculated value in a corresponding countermeasure level. Subsequently, the second calculation unit 18D may calculate the second risk value by using the newly calculated value of the countermeasure level.

Subsequently, when the second risk value is calculated next time or later, that is, when the second risk value based on new vulnerability information is calculated, the second calculation unit 18D may calculate the second risk value by using the previously updated risk analysis result information 16B. That is, the second calculation unit 18D may calculate the second risk value based on the analysis result of the previous risk analysis.

Specifically, for example, it is assumed that by reflecting the analysis result from the previous calculation of the second risk value, the countermeasures corresponding to the threat type of the threat that can be countered by the software A being the installed software in the target system 30 is set to none in the risk analysis result information 16B (that is, remove “O” from the countermeasure column), and the newly calculated value of the countermeasure level is registered as the corresponding countermeasure level. Subsequently, it is assumed that the second calculation unit 18D calculates the second risk value by using the value of the countermeasure level. In this case, when the second risk value is next calculated, the second calculation unit 18D may newly calculate a second risk value based on the analysis result reflected in the previous analysis, that is, the analysis result of the previous risk analysis in which it was deemed that no countermeasures against the threat have been taken by the software A.

More specifically, for example, it is assumed that the installed software in the target system 30 is software G, software H, and software I. In addition, it is assumed that these installed software are able to counter unauthorized access.

It is assumed that the software G, the software H, and the software I are used as countermeasures (three marks “O” are registered) for “one-way gateway”, “WAF”, and “authentication of communication partners”, respectively, in response to the threat type “unauthorized access” in the risk analysis result information 16B.

Subsequently, it is assumed that vulnerable installed software represented by vulnerability information acquired for the first time is the software G. In this case, when the second risk value is calculated based on the vulnerability information acquired for the first time, for example, the second calculation unit 18D performs a risk analysis as no countermeasures by the “one-way gateway” using the software G. In this case, since “O” indicating the presence of countermeasures registered in the “one-way gateway” by the software G is removed, the number of “O”s indicating the presence of countermeasures against “unauthorized access” is 2. Therefore, the second calculation unit 18D calculates, for example, a risk value “C” as the second risk value from a countermeasure level corresponding to the number of countermeasures.

Subsequently, it is assumed that the vulnerable installed software represented by the vulnerability information acquired for the second time is the software H. In this case, when the second risk value is calculated based on the vulnerability information acquired for the second time, for example, the second calculation unit 18D performs a risk analysis as no countermeasure by the “WAF” using the software H. In this case, since “O” indicating the presence of countermeasures registered in the “WAF” by the software H is further removed, the number of “O”s indicating the presence of countermeasures against “unauthorized access” is 0. Therefore, the second calculation unit 18D calculates a risk value “B”, which is increased from the risk value “C”, as the second risk value from a countermeasure level corresponding to the number of countermeasures.

On the other hand, when the second calculation unit 18D calculates the second risk value in the same manner without using the previously updated risk analysis result information 16B, the second risk value calculated on the basis of the vulnerability information acquired for the second time above is the risk value “C” with no change from the first time.

Therefore, in this way, when the second risk value is calculated next time or later, that is, when the second risk value based on new vulnerability information is calculated, the second calculation unit 18D can calculate the second risk value by using the previously updated risk analysis result information 16B, thereby calculating the second risk value based on the analysis result of the previous risk analysis.

The first calculation unit 18C may calculate the first risk value in the same manner as above by using the risk analysis result information 16B updated by the second calculation unit 18D.

Therefore, in this case, the second calculation unit 18D updates the risk analysis result information 16B by using the analysis result of the risk analysis, so that when risk values (the first risk value and the second risk value) are calculated the next time or later, the first calculation unit 18C and the second calculation unit 18D can calculate the risk values based on the analysis result of the previous risk analysis.

The output unit 18E will be explained below.

The output unit 18E outputs the damage potential information.

The damage potential information is information representing a potential damage to the target system 30 caused by the vulnerability of the installed software.

The damage potential information includes at least risk value change information. The risk value change information represents a change in the second risk value with respect to the first risk value. That is, the risk value change information is information representing a change in risk value from the presence of countermeasures against the threats of the threat types that can be countered by the installed software to the absence of the countermeasures against the threats. For example, it is assumed that the first risk value calculated by the first calculation unit 18C is “B” and the second risk value calculated by the second calculation unit 18D is “A”. In this case, the output unit 18E outputs damage potential information including information representing a change from the first risk value “B” to the second risk value “A” as the risk value change information.

The damage potential information may further include threat types of threats having damage potential according to the risk value change information. That is, the output unit 18E may output damage potential information including the risk value change information on the threat type of the threat that can be countered by the installed software and the threat type.

The damage potential information may further include information on the presence or absence of damage potential. The information on the presence or absence of damage potential is information representing the presence of damage potential or absence of damage potential. The output unit 18E may generate and output information on the presence or absence of damage potential that represents the presence of damage potential when the change in risk value represented by the risk value change information represents an increase in risk and represents the absence of damage potential when the change represents no change or a decrease in risk. For example, it is assumed that the change in risk value represented by the risk value change information is a change representing an increase in risk from the first risk value “B” to the second risk value “A”. In this case, the output unit 18E may generate information on the presence or absence of damage potential that represents the presence of damage potential, and output damage potential information further including the information on the presence or absence of damage potential.

The output unit 18E outputs the damage potential information to at least one of the storage unit 16, the UI unit 14, and an external device such as the external device 20. That is, outputting the damage potential represents at least one of storage in the storage unit 16, display on the UI unit 14, and transmission to the external device.

For example, the output unit 18E stores the damage potential information in the storage unit 16. The output unit 18E stores the damage potential information in the storage unit 16, which enables the analysis result to be stored and used for a trend analysis and other data applications.

The output unit 18E also transmits the damage potential information to an external information processing device such as an external device via the communication unit 12. The output unit 18E transmits the damage potential information to the external information processing device, so that the information processing device receiving the damage potential information can use the information for a trend analysis and other data applications.

The output unit 18E also displays the damage potential information on the UI unit 14.

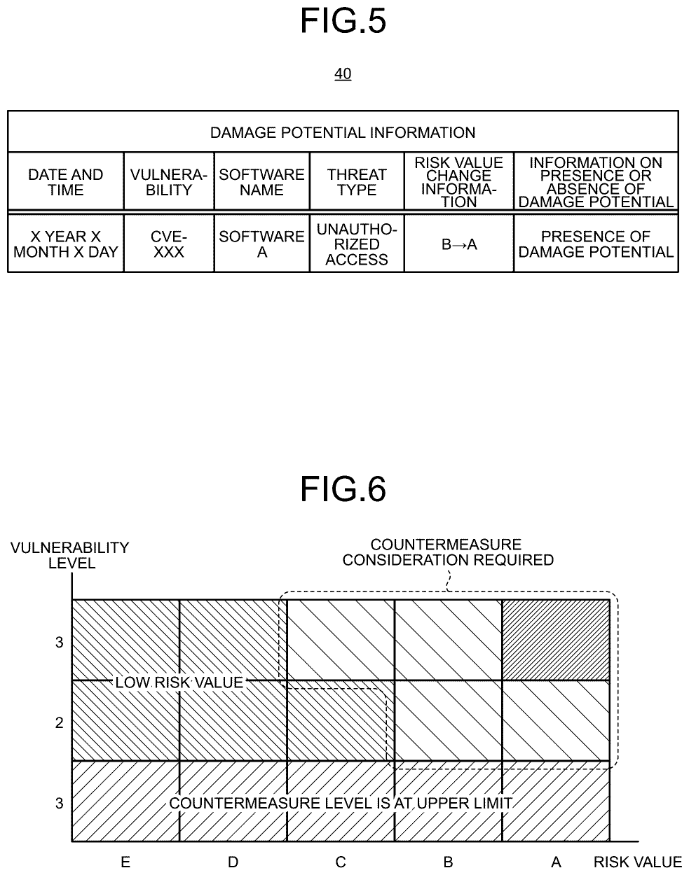

FIG. 5 is a schematic diagram of an example of a display screen 40 displayed in the UI unit 14.

For example, the output unit 18E displays the display screen 40 representing the damage potential information on the UI unit 14. As illustrated in FIG. 5, for example, the display screen 40 including damage potential information including the threat type, the risk value change information, the information on the presence or absence of damage potential, and the like is displayed on the UI unit 14. The output unit 18E may output the damage potential information further including the date and time when the comparison between the first and second risk values was conducted, the CVE number, and the software name of the installed software.

By outputting the damage potential information, the output unit 18E can enable to easily identify whether the security risk of the target system 30 changes due to the vulnerability of the installed software with a reported vulnerability and what kind of damage (threat) the target system 30 may be subjected to.

The output unit 18E may output the damage potential information further including at least one of the following: the risk value change information, the countermeasure level calculated from the vulnerability level, and information representing whether the security risk for the threat has changed.

In detail, the output unit 18E assumes a risk analysis using an analysis method in accordance with the “Security Risk Analysis Guide for Control Systems” published by the IPA, and determines whether the security risk of the target system 30 changes due to a change in the countermeasure level and what kind of damage (threat) may occur.

The countermeasure level is information calculated from the risk value and the vulnerability level, and is represented, for example, by a matrix illustrated in FIG. 6. FIG. 6 is an explanatory diagram illustrating an example of a countermeasure level.

The output unit 18E compares a first countermeasure level calculated from the first risk value and the vulnerability level calculated by the first calculation unit 18C with a second countermeasure level calculated from the second risk value and the vulnerability level calculated by the second calculation unit 18D. The first countermeasure level and the second countermeasure level are examples of countermeasure levels.

Subsequently, when a change from the first countermeasure level calculated from the first risk value, which is the case with countermeasures, to the second countermeasure level calculated from the second risk value, which is the case without countermeasures, represents a change to a higher risk countermeasure level, the output unit 18E determines that the security risk for the threat has changed. Specifically, when the change from the first countermeasure level to the second countermeasure level is from a lower risk “countermeasure level is at upper limit” to a higher risk “countermeasure consideration required” or from a lower risk “low risk value” to a higher risk “countermeasure consideration required”, the output unit 18E determines that the security risk for the threat has changed. Subsequently, the output unit 18E outputs the damage potential information further including at least one of the countermeasure level and information representing whether the security risk for the threat has changed. In this case, the output unit 18E can further provide the comparison result of security risk changes considering a countermeasure priority determined from the countermeasure level.

The output unit 18E may further output a threat type to be output by referring to information in the Description column on the NVD vulnerability information page or the assumed impact column on the JVN iPedia vulnerability information page. This process allows the output unit 18E to output more detailed information for threat types.

Return to FIG. 2 to continue the explanation.

The update unit 18F updates the correspondence information 16A. In detail, the update unit 18F updates the correspondence information 16A to be information representing the latest state of the target system 30. The update unit 18F may update the correspondence information 16A in response to user's instructions to operate the UI unit 14 in at least one of the following cases: when new security countermeasure software is installed in the target system 30, when new security countermeasure software is scheduled to be installed in the target system 30, when the security countermeasure software installed in the target system 30 is uninstalled, and when a change occurs in the threat type of a threat that can be countered by the security countermeasure software.

The update unit 18F updates the correspondence information 16A to be information representing the latest state of the target system 30. The processing unit 18 may be configured without the update unit 18F.

An example of an information processing flow to be performed by the information processing device 10 of the present embodiment will be explained.

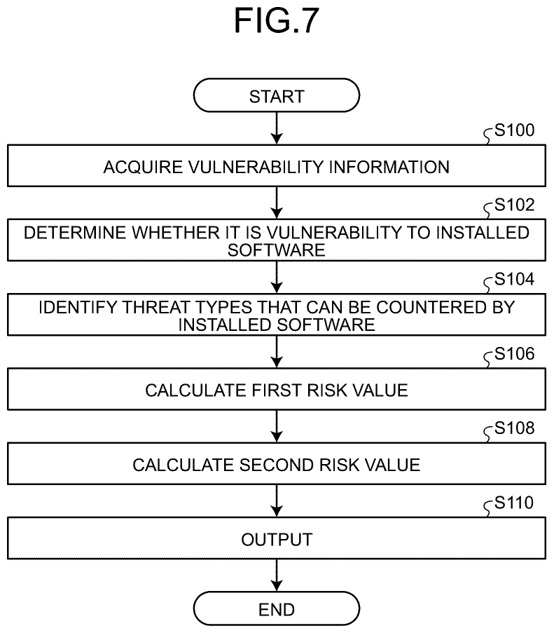

FIG. 7 is a flowchart illustrating an example of an information processing flow to be performed by the information processing device 10 of the present embodiment.

The vulnerability determination unit 18A acquires newly reported vulnerability information (step S100). Subsequently, the vulnerability determination unit 18A determines whether a vulnerability represented by the vulnerability information acquired at step S100 is a vulnerability to the installed software being the security countermeasure software installed in the target system 30 (step S102). The vulnerability determination unit 18A outputs, to the first identifying unit 18B, information representing the security countermeasure software installed in the target system 30 and having a reported vulnerability, the vulnerability being determined on the basis of the new vulnerability information.

The first identifying unit 18B identifies threat types that can be countered by the installed software, which is the security countermeasure software installed in the target system 30, out of the security countermeasure software with a reported vulnerability (step S104). For example, the first identifying unit 18B receives, from the vulnerability determination unit 18A, the vulnerability information and information on the installed software installed in the target system 30 and having a vulnerability. The first identifying unit 18B reads the information on the installed software received from the vulnerability determination unit 18A to identify the installed software determined by the vulnerability determination unit 18A to be vulnerable to the installed software in the target system 30. Subsequently, the first identifying unit 18B identifies the threat types that can be countered by the identified installed software with a reported vulnerability.

The first calculation unit 18C calculates the first risk value, which is a risk value for the threat of the threat type identified at step S104, when countermeasures have been taken by the installed software (step S106). For example, the first calculation unit 18C calculates the first risk value on the basis of the threat type identified at step S104 and the risk analysis result information 16B.

The second calculation unit 18D calculates the second risk value, which is a risk value for the threat of the threat type identified at step S104 when no countermeasures have been taken by the installed software (step S108). The second calculation unit 18D calculates the second risk value by using the same analysis method as the analysis method performed at step S106 by the second calculation unit 19C.

The output unit 18E outputs the damage potential information including at least the risk value change information representing a change in the second risk value calculated at step S108 with respect to the first risk value calculated at step S106 (step S110). Subsequently, the routine is terminated.

As explained above, the information processing system 1 of the present embodiment includes the first identifying unit 18B, the first calculation unit 18C, the second calculation unit 18D, and the output unit 18E. The first identifying unit 18B identifies the threat types that can be countered by the installed software, which is the security countermeasure software installed in the target system 30, out of the security countermeasure software with a reported vulnerability. The first calculation unit 18C calculates the first risk value for the threat of the identified threat type when countermeasures have been taken by the installed software. The second calculation unit 18D calculates the second risk value for the threat of the identified threat type when no countermeasures have been taken by the installed software. The output unit 18E outputs damage potential information including risk value change information representing a change in the second risk value with respect to the first risk value.

Here, vulnerabilities in security countermeasure software affect not only the software itself, but also the target system 30 countered by the security countermeasure software. However, in the related art, even when vulnerabilities are found in security countermeasure software, evaluating the risk of the target system 30 countered by the software has been difficult. That is, in the related art, evaluating the risk to the target system 30 due to the vulnerability of the security countermeasure software has been difficult.

On the other hand, the information processing system 1 of the present embodiment identifies threat types that can be countered by the installed software in the target system 30 out of the security countermeasure software with a reported vulnerability, and outputs the damage potential information including the risk value change information representing a change in the first risk value when countermeasures have been taken by the installed software against the threats of the identified threat types and the second risk value when no countermeasures have been taken by the installed software.

Therefore, when a new vulnerability in the security countermeasure software is reported, the information processing system 1 of the present embodiment can output damage potential information being information that can identify whether the risk of the target system 30 increases.

Consequently, the information processing system 1 of the present embodiment can evaluate risks to the target system 30 due to vulnerabilities in the security countermeasure software.

### Second Embodiment

The present embodiment will explain a form in which the second risk value is calculated for a plurality of types of threats that can be countered by installed software, considering an impact on information security elements explained in vulnerability information and assuming that countermeasures are taken against some types of threats.

In the present embodiment, the same functional components as in the above embodiment are given the same codes and detailed explanations thereof will be omitted.

FIG. 1 is a schematic diagram illustrating an example of the configuration of an information processing system 2 of the present embodiment. The information processing system 2 has the same configuration as the information processing system 1 of the above embodiment, except that an information processing device 11 is provided instead of the information processing device 10.

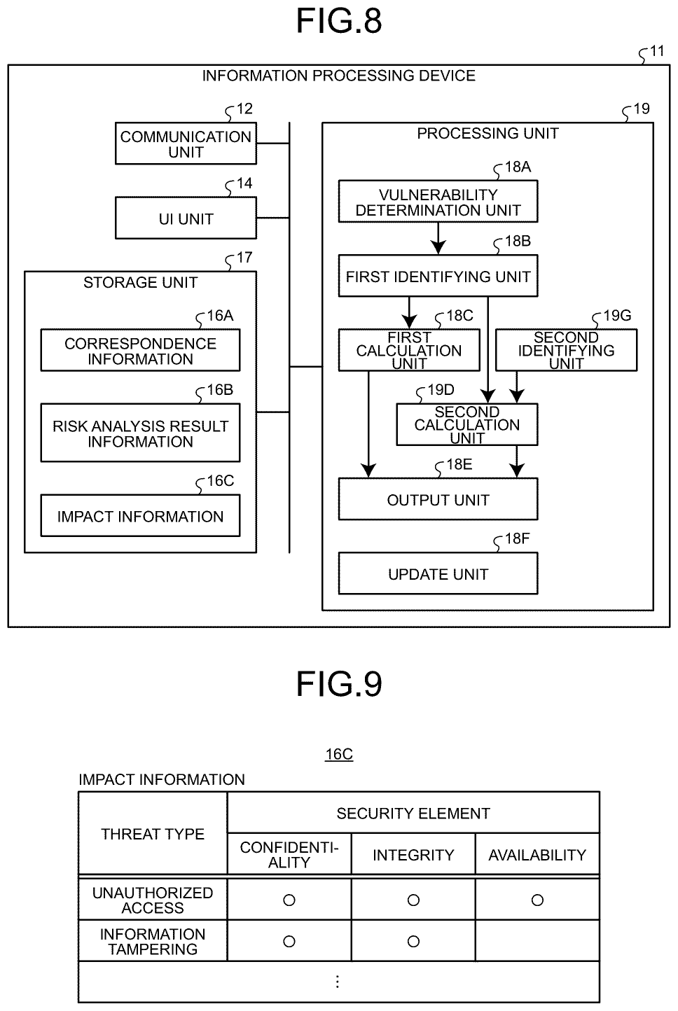

FIG. 8 is a block diagram illustrating an example of the functional configuration of the information processing device 11 of the present embodiment.

The information processing device 11 includes the communication unit 12, the UI unit 14, a storage unit 17, and a processing unit 19. The communication unit 12, the UI unit 14, the storage unit 17, and the processing unit 19 are connected via a bus or the like to be able to exchange data or signals.

The information processing device 11 is the same as the information processing device 10 of the above embodiment, except that the storage unit 17 and the processing unit 19 are provided instead of the storage unit 16 and the processing unit 18.

The storage unit 17 further stores impact information 16C, in addition to the correspondence information 16A and the risk analysis result information 16B. Details of the impact information 16C will be explained below.

The processing unit 19 includes the vulnerability determination unit 18A, the first identifying unit 18B, the first calculation unit 18C, a second calculation unit 19D, the output unit 18E, the update unit 18F, and a second identifying unit 19G.

At least one of the vulnerability determination unit 18A, the first identifying unit 18B, the first calculation unit 18C, the second calculation unit 19D, the output unit 18E, the update unit 18F, and the second identifying unit 19G is implemented by one or more processors, for example. For example, each of the units may be implemented by causing a processor such as a CPU to execute a computer program, that is, by software. Each of the units may be implemented by a processor such as a dedicated IC, that is, hardware. Each of the above units may be implemented using a combination of software and hardware. When a plurality of processors are used, each processor may implement one of the units or two or more of the units. In addition, at least one of the functional units provided in the processing unit 19 may be provided in an external information processing device that is communicatively connected to the information processing device 11 via the network NW. The impact information 16C may be configured to be stored in the external information processing device that is communicatively connected to the information processing device 11 via the network NW.

The processing unit 19 is the same as the processing unit 18 of the above embodiment, except that the second calculation unit 19D is provided instead of the second calculation unit 18D and the second identifying unit 19G is further provided.

On the basis of the vulnerability information and the impact information 16C, the second identifying unit 19G identifies, among threats that can be countered by the installed software, the threat types of threats that are affected by the vulnerability represented by the vulnerability information. The vulnerability information used by the second identifying unit 19G for identifying is the vulnerability information acquired by the vulnerability determination unit 18A.

As explained above, the vulnerability information defines the threat type of a threat having a vulnerability and an information security element representing at least one of confidentiality, integrity, and availability affected by the threat of the threat type. Therefore, the second identifying unit 19G first identifies, on the basis of the vulnerability information, an element affected by a newly reported vulnerability among the three information security elements: confidentiality, integrity, and availability.

In detail, the second identifying unit 19G identifies the element affected by the vulnerability among the above three information security elements by acquiring information by referring to a common vulnerability scoring system (CVSS), for example. The second identifying unit 19G may also identify the elements affected by the vulnerability by acquiring or setting information in other ways. For example, the second identifying unit 19G may refer to the CVSS Severity column of the NVD vulnerability information page, and identify the vulnerability as having an impact on the relevant element when it is rated high or low out of high, low, or none for each of the above three information security elements. When the vulnerability is rated as either full or partial, out of full, partial, or none for each of the above three information security elements, the vulnerability may be identified as having an impact on the relevant element.

FIG. 9 is a schematic diagram of an example of the data structure of the impact information 16C. The impact information 16C is information defining the presence or absence of an impact on information security elements for each threat type. In other words, the impact information 16C is information representing which of the three information security elements is affected by the threat type. In FIG. 9, “O” means that the threat of a corresponding threat type affects a corresponding information security element. A blank space means that no information security element is affected.

The impact information 16C may be generated in advance by a user's instruction to the UI unit 14 and stored in the storage unit 17. The impact information 16C may be mechanically generated and stored in the storage unit 17 in advance. That is, the processing unit 19 may generate the impact information 16C in advance and store the generated impact information 16C in the storage unit 17. The correspondence between threat types and information security elements in the impact information 16C may be arbitrarily set by a user who operates the UI unit 14 or the like, may be mechanically set, or may be set in any way. It may also be set up so that a plurality of information security elements are affected for one threat type.

On the basis of the vulnerability information and the impact information 16C, the second identifying unit 19G identifies the threat types affected by the vulnerability represented by the vulnerability information among the threat types of threats that can be countered by the installed software.

For example, it is assumed that the second identifying unit 19G identifies a vulnerability in the element “availability” being one of the three information security elements, from the vulnerability information. It is assumed that two threat types that can be countered by the installed software and identified by the first identifying unit 18B are unauthorized access and information tampering. As illustrated in FIG. 9, the impact information 16C indicates that unauthorized access affects three elements: confidentiality, integrity, and availability, while information tampering affects two elements: confidentiality and integrity. In this case, the second identifying unit 19G identifies, from the impact information 16C, the threat type “unauthorized access” that affects the element “availability” identified as being vulnerable. The second identifying unit 19G identifies threat types other than those identified as having an impact on the vulnerability as threat types having no impact on the vulnerability.

Subsequently, the second identifying unit 19G notifies the second calculation unit 19D of the threat types that are affected by the vulnerability and those that are not affected by the vulnerability.

When a plurality of threat types are identified by the first identifying unit 18B, the second calculation unit 19D calculates the second risk value when the threat of the threat type identified by the second identifying unit 19G that is affected by the vulnerability is assumed to have no countermeasure and the threat of the threat type identified by the second identifying unit 19G that is not affected by the vulnerability is assumed to have countermeasure, among the threat types.

An example of an information processing flow to be performed by the information processing device 11 of the present embodiment will be explained.

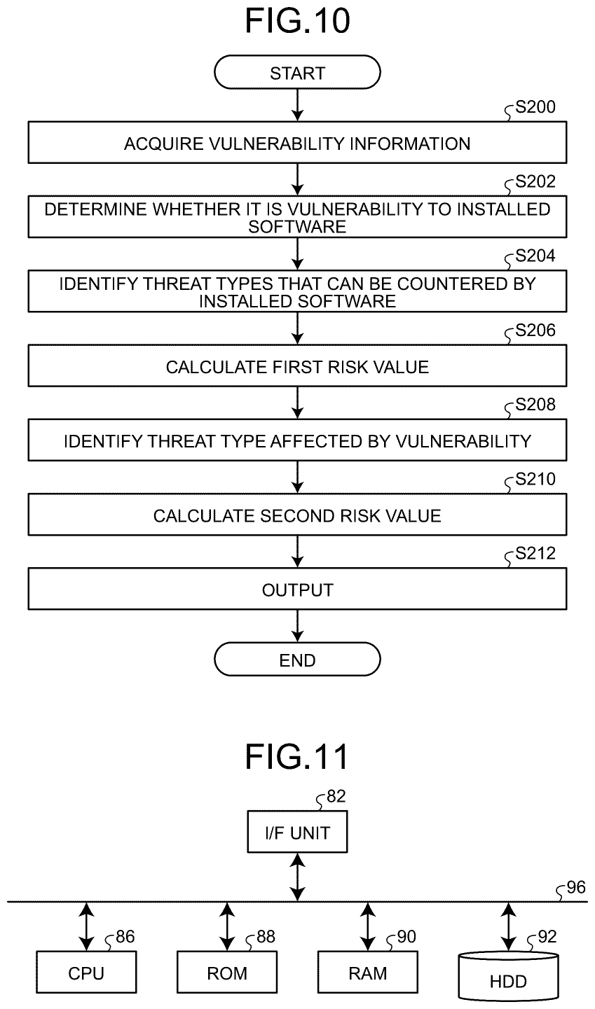

FIG. 10 is a flowchart illustrating an example of an information processing flow to be performed by the information processing device 11 of the present embodiment.

The information processing device 11 performs processes of step S200, S202, S204, and S206 in the same manner as the processes of step S100, S102, S104, and step S106 (see FIG. 7) performed by the information processing device 10.

In detail, the vulnerability determination unit 18A of the information processing device 11 acquires newly reported vulnerability information (step S200). Subsequently, the vulnerability determination unit 18A determines whether a vulnerability represented by the vulnerability information acquired at step S200 is a vulnerability to the installed software (step S202). The first identifying unit 18B identifies a threat type that can be countered by the installed software, which has been determined to be a vulnerability to the installed software at step S202 (step S204). The second calculation unit 18D calculates the first risk value, which is a risk value for the threat of the threat type identified at step S204, when the countermeasure by the installed software is taken (step S206).

On the basis of the vulnerability information acquired at step S200 and the impact information 16C, the second identifying unit 19G identifies a threat type affected by the vulnerability represented by the vulnerability information among the threat types of threats that can be countered by the installed software (step S208).

The second calculation unit 18D calculates the second risk value when the threat of the threat type identified at step S208 that is affected by the vulnerability is assumed to have no countermeasure and threats of other threat types that are not affected by the vulnerability are assumed to have countermeasure, among the threat types identified at step S204 (step S210).

The output unit 18E outputs the damage potential information including at least the risk value change information representing a change in the second risk value calculated at step S210 with respect to the first risk value calculated at step S206 (step S212). Subsequently, the routine is terminated.

As explained above, in the information processing system 2 of the present embodiment, on the basis of the threat type of a threat having a vulnerability, vulnerability information defining an information security element representing at least one of confidentiality, integrity, and availability affected by the threat of the threat type, and the impact information 16C, the second identifying unit 19G identifies, among threat types of threats that can be countered by installed software, a threat type affected by a vulnerability represented by the vulnerability information. Subsequently, the second calculation unit 19D calculates the second risk value when the threat of the threat type identified by the second identifying unit 19G that is affected by the vulnerability is assumed to have no countermeasure and the threat of the threat type identified by the second identifying unit 19G that is not affected by the vulnerability is assumed to have countermeasure, among the threat types identified by the first identifying unit 18B.

In this way, in the present embodiment, the second calculation unit 19D calculates the second risk value when the threats of threat types having an impact on the vulnerability identified by the second identifying unit 19G are assumed to have no countermeasures and the threat types of threat types having no impact on the vulnerability are assumed to have countermeasures, in consideration of an impact on confidentiality, integrity, and availability being the three information security elements explained in the vulnerability information.

Therefore, in addition to the effects of the above embodiment, the information processing system 2 of the present embodiment can provide damage potential information narrowed down to threat types that truly affect the target system 30.

An example of the hardware configuration of the information processing device 10 and the information processing device 11 of the above embodiment will be explained.

FIG. 11 is a diagram illustrating an example of the hardware configuration of the information processing device 10 and the information processing device 11 of the above embodiment.

The information processing device 10 and the information processing device 11 each include a control device such as a CPU 86, storage devices such as a read only memory (ROM) 88, a random access memory (RAM) 90, and a hard disk drive (HDD) 92, an I/F unit 82 being an interface with various devices, and a bus 96 connecting various parts, and have a hardware configuration using a normal computer.

In the information processing device 10 and the information processing device 11, each of the above parts is implemented on a computer by the CPU 86 reading computer programs from the ROM 88 onto the RAM 90 and executing the read computer programs.

The computer programs for executing the above processes performed by the information processing device 10 and the information processing device 11 may be stored in the HDD 92. The computer programs for performing the above processes performed by the information processing device 10 and the information processing device 11 may be pre-embedded in the ROM 88 and provided.

The computer programs for performing the above processes, which are executed by the information processing device 10 and the information processing device 11, may be stored on a computer-readable storage medium, such as a CD-ROM, a CD-R, a memory card, a digital versatile disc (DVD), and a flexible disk (FD), in an installable or executable file format, and provided as a computer program product. The computer programs for performing the above processes, which are executed by the information processing device 10 and the information processing device 11, may be stored on a computer connected to a network such as the Internet and be downloaded over the network so as to be provided. The computer programs for performing the above processes, which are executed by the information processing device 10 and the information processing device 11, may be provided or distributed over the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising one or more hardware processors configured to:
identify a threat type capable of being countered by installed software being security countermeasure software installed in a target system, from among security countermeasure software with a reported vulnerability;
calculate a first risk value when a countermeasure is taken by the installed software for a threat of the identified threat type;
calculate a second risk value when no countermeasure is taken by the installed software for the threat of the identified threat type; and
output damage potential information including risk value change information representing a change in the second risk value with respect to the first risk value.

2. The system according to claim 1, wherein the one or more hardware processors are configured to output the damage potential information further including the threat type of the threat having damage potential according to the risk value change information.

3. The system according to claim 1, wherein the one or more hardware processors are configured to output the damage potential information further including information on presence or absence of damage potential that represents presence of damage potential when a change in a risk value represented by the risk value change information represents an increase in risk and absence of damage potential when the change represents no change or a decrease in risk.

4. The system according to claim 1, wherein
the one or more hardware processors are configured to:
calculate the first risk value by a risk analysis comparing risk values before and after the countermeasure by the installed software for the threat of the identified threat type; and
calculate the second risk value by the risk analysis when no countermeasure is taken by the installed software for the threat of the identified threat type.

5. The system according to claim 1, wherein the one or more hardware processors are configured to calculate the first risk value based on risk analysis result information obtained by comparing risk values before and after the countermeasure against the threat when the countermeasure is taken by the installed software.

6. The system according to claim 5, wherein the one or more hardware processors are configured to update the risk analysis result information by using an analysis result of a risk analysis for calculating the second risk value.

7. The system according to claim 1, wherein the one or more hardware processors are further configured to determine whether a vulnerability represented by newly reported vulnerability information is a vulnerability to the installed software being the security countermeasure software installed in the target system, and
the one or more hardware processors are configured to identify the installed software for which it is determined that the vulnerability is to the installed software in the target system, and the threat type capable of being countered by the installed software.

8. The system according to claim 1, wherein the one or more hardware processors are configured to identify the threat type capable of being countered by the installed software, based on correspondence information that associates the installed software in the target system with a threat type of a threat capable of being countered by the installed software.

9. The system according to claim 8, wherein the one or more hardware processors are further configured to update the correspondence information.

10. The system according to claim 1, wherein the one or more hardware processors are configured to output the damage potential information further including a countermeasure level calculated from the risk value change information and a vulnerability level.

11. The system according to claim 1, wherein the one or more hardware processors are configured to display the damage potential information on a display.

12. The system according to claim 1, wherein the one or more hardware processors are further configured to identify a threat type affected by a vulnerability represented by vulnerability information among threat types of threats capable of being countered by the installed software, based on the vulnerability information and impact information, the vulnerability information defining a threat type of a threat having a vulnerability and an information security element representing at least one of confidentiality, integrity, and availability affected by the threat of the threat type, the impact information defining presence or absence of an impact on the information security element for each threat type, and
the one or more hardware processors are configured to calculate the second risk value when no countermeasure is taken for a threat of the threat type identified as affected by the threat, and countermeasure is taken for a threat of the threat type identified as not affected by the vulnerability, among a plurality of threat types identified as capable of being countered by the installed software.

13. An information processing method performed by an information processing device, the information processing method comprising:
identifying a threat type capable of being countered by installed software being security countermeasure software installed in a target system, from among security countermeasure software with a reported vulnerability;
calculating a first risk value when a countermeasure is taken by the installed software for a threat of the identified threat type;
calculating a second risk value when no countermeasure is taken by the installed software for the threat of the identified threat type; and
outputting damage potential information including risk value change information representing a change in the second risk value with respect to the first risk value.

14. A computer program product having a non-transitory computer readable medium including programmed instructions, wherein the programmed instructions, when executed by a computer, cause the computer to execute:
identifying a threat type capable of being countered by installed software being security countermeasure software installed in a target system, from among security countermeasure software with a reported vulnerability;
calculating a first risk value when a countermeasure is taken by the installed software for a threat of the identified threat type;
calculating a second risk value when no countermeasure is taken by the installed software for the threat of the identified threat type; and
outputting damage potential information including risk value change information representing a change in the second risk value with respect to the first risk value.
